(19) United States
(12) Patent Application Publication
(10) Pub. No.: US 2016/0310350 A1
(43) Pub. Date: Oct. 27, 2016

(54) MASSAGING DEVICE HAVING ADJUSTABLE STRUCTURE

(71) Applicant: Paul CHEN, (US)

(72) Inventor: Paul CHEN, Vancouver (CA)

(21) Appl. No.: 14/694,014

(22) Filed: Apr. 23, 2015

(51) Int. Cl. A61H 15/00

(52) U.S. Cl. CPC A61H 15/00

(57) ABSTRACT

A massaging device includes a housing having a chamber and a number of orifices communicating with the chamber of the housing, one or more beams movably engaged in the housing, and the beams each include a number of massaging members aligned with the orifices of the housing, and an actuator is rotatably engaged in the housing and includes one or more protrusions for engaging with the beams and for moving the massaging members of the beams into and out of the orifices of the housing and for actuating the massaging members to engage with and to massage the users. A shaft is engaged in the housing and secured to the actuator for rotating the actuator relative to the housing.

### BACKGROUND OF THE INVENTION

1. Field of the Invention

The present invention relates to a massaging device, and more particularly to a massaging device including an adjustable structure or configuration for adjusting the protrusion or extension of the massaging members and for adjusting the massaging effects to the users.

2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui discloses one of the typical massaging devices also comprising a relatively harder or stronger inner housing having a cylindrical shape or contour or structure, and a relatively softer or resilient outer layer for selectively contacting or engaging with the users and for massaging purposes.

However, the outer layer includes a smooth outer peripheral structure or contour that may not be frictionally contacted or engaged with the users such that the users may not be massaged with the typical massaging devices.

U.S. Pat. No. 8,888,808 to Park discloses another typical massaging device comprising a planar base member having a number of projections or protrusions extended outwardly therefrom for frictionally contacting or engaging with the users and for massaging purposes.

However, the projections or protrusions extended outwardly from the planar base member, but may not be adjusted relative to the planar base member, and thus may not provide different massaging forces or effects to the users.

The present invention has arisen to mitigate and/or obviate the afore-described disadvantages of the conventional massaging devices.

### SUMMARY OF THE INVENTION

The primary objective of the present invention is to provide a massaging device including an adjustable structure or configuration for adjusting the protrusion or extension of the massaging members and for adjusting the massaging effects to the users.

In accordance with one aspect of the invention, there is provided a massaging device comprising a housing including a chamber formed therein, and including a number of orifices formed in the housing and communicating with the chamber of the housing, at least one beam received and engaged in the chamber of the housing and movable relative to the housing, and the beam including a number of massaging members extended therefrom and aligned with the orifices of the housing respectively, and an actuator rotatably received and engaged in the chamber of the housing and including at least one protrusion extended therefrom for contacting and engaging with the beam and for selectively moving the massaging members of the beam into and out of the orifices of the housing respectively and for selectively contacting and engaging and massaging the user.

The housing includes a shaft rotatably received and engaged in the chamber of the housing and secured to the actuator and moved in concert with the actuator. The housing includes two end portions, and two covers attached to the end portions of the housing respectively, and the shaft includes two end portions rotatably engaged through the covers and rotatably supported in the chamber of the housing with the covers.

The covers each include at least one opening formed therein, and the beam includes two end portions slidably engaged with the opening of the cover for guiding the beam to move relative to the housing. The actuator includes at least one recess formed therein for engaging with the beam. The actuator includes a depression formed in the protrusion for engaging with the beam. The actuator includes a notch formed in the protrusion for engaging with the beam. The least one beam includes a bulge extended therefrom for engaging with the protrusion.

The housing includes two end portions, and two end caps are disposed in the end portions of the housing respectively, and the end caps each include an actuating element having at least one projection extended therefrom for contacting and engaging with the beam and for selectively moving or forcing the massaging members of the beam to move into or out of the housing. The actuating elements of the end caps each include at least one recess formed therein for engaging with the beam.

The actuating elements of the end caps each include a depression formed in the projection for engaging with the beam. The actuating elements of the end caps each include a notch formed in the projection for engaging with the beam. The end caps each include a knob provided thereon. The beam includes a bulge extended therefrom for engaging with the projection.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a massaging device in accordance with the present invention;

FIG. 2 is an exploded view of the massaging device as seen from one direction;

FIG. 3 is another exploded view as seen from the other direction of the massaging device;

FIG. 4 is a cross sectional view of the massaging device, taken along lines 4-4 of FIG. 1;

FIG. 5 is another cross sectional view of the massaging device, taken along lines 5-5 of FIG. 1; and

FIGS. 6, 7 are cross sectional views similar to FIG. 5, illustrating the operation of the massaging device.

### DETAILED DESCRIPTION OF THE PREFERRED EMBODIMENT

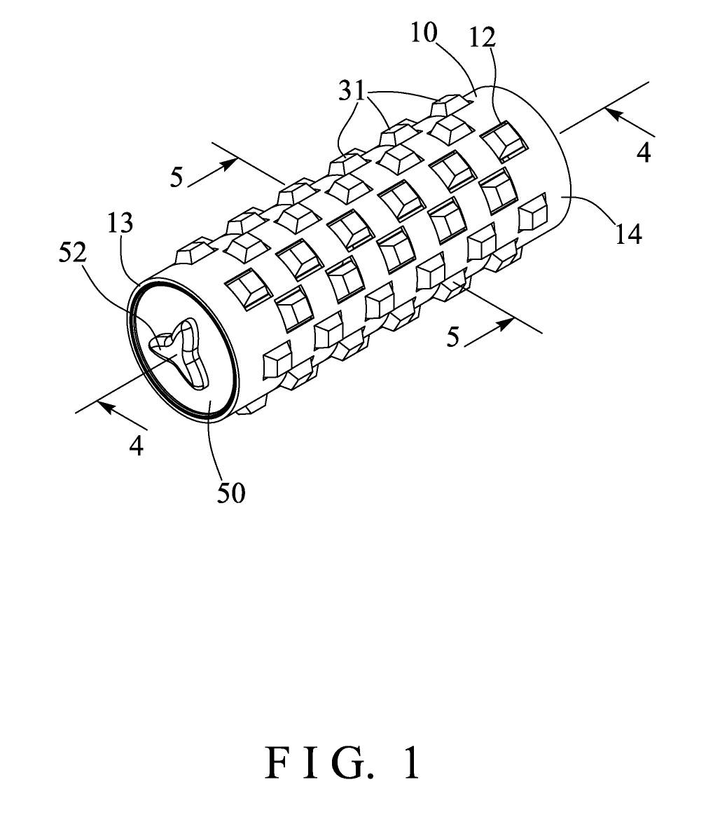

Referring to the drawings, and initially to FIGS. 1-5, a massaging device in accordance with the present invention comprises a receptacle or housing 10 made of a relatively harder or stronger materials, such as plastic, synthetic materials or the like, the housing 10 preferably includes a cylindrical shape or contour having a bore or inner compartment or chamber 11 formed therein, and includes a number of orifices 12 formed therein and communicating with the chamber 11 of the housing 10, the housing 10 includes two end portions 13, 14.

Two covers 20, 21 are attached or mounted or secured to the end portions 13, 14 of the housing 10 respectively, and solidly and stably secured to the housing 10 with welders, adhesive materials or the like, the covers 20, 21 each include one or more (such as four) openings 22 formed therein and arranged or located at the outer peripheral portion of the respective cover 20, 21, and the covers 20, 21 each include a center hole 23 formed therein. It is preferable, but not necessary that the openings 22 of the covers 20, 21 are aligned with each other.

One or more (such as four) bars or beams 30 are received or engaged in the chamber 11 of the housing 10 and movable relative to the housing 10, and each beam 30 include a number of massaging members 31 extended outwardly therefrom and aligned with and slidably engaged with the orifices 12 of the housing 10 respectively, and arranged for allowing the massaging members 31 to be selectively moved or extended into and out of the housing 10. The beams 30 each include a triangular or wedge-shaped swelling or bulge 32 extended inwardly therefrom, best shown in FIGS. 5-7.

The beams 30 and/or the bulges 32 are made of a relatively harder or stronger material, such as plastic, synthetic materials or the like, and the massaging members 31 are made of a relatively softer or resilient material, such as plastic, synthetic materials, rubber or the like for softly and comfortably contacting or engaging with the users and for massaging purposes. The beams 30 and/or the massaging members 31 may further include a relatively softer or resilient or spongy outer layer 34 applied thereon for comfortably contacting or engaging with the users. The beams 30 each include one or more (such as two) end portions 33 movably or slidably engaged with the openings 22 of the covers 20, 21 for limiting and guiding the beams 30 to move radially relative to the housing 10 (FIGS. 5-7).

A spindle or shaft 40 is rotatably engaged through the center holes 23 of the covers 20, 21 and rotatably straddled and supported in the chamber 11 of the housing 10 with the covers 20, 21, and an actuator 41 is attached or mounted or secured on the shaft 40 and moved or rotated in concert with the shaft 40; or the shaft 40 includes the actuator 41 formed or provided thereon, and the actuator 41 includes one or more (such as four) protrusions 42 extended radially and outwardly therefrom for contacting or engaging with the beams 30 respectively, and includes one or more (such as four) recesses 43 formed therein and located between the protrusions 42 respectively.

The actuator 41 is rotatably received or engaged in the chamber 11 of the housing 10, and further includes a depression 44 and a notch 45 formed in each of the protrusions 42, best shown in FIGS. 5-7, in which the depression 44 is located at the tip or outermost end portion of the respective protrusion 42, and the notch 45 is located between the depression 44 and the recess 43 of the respective protrusion 42. In operation, as shown in FIG. 5, the massaging members 31 of the beams 30 may be forced to move out through the orifices 12 of the housing 10 when the bulges 32 of the beams 30 are engaged with the depressions 44 of the actuator 41 respectively.

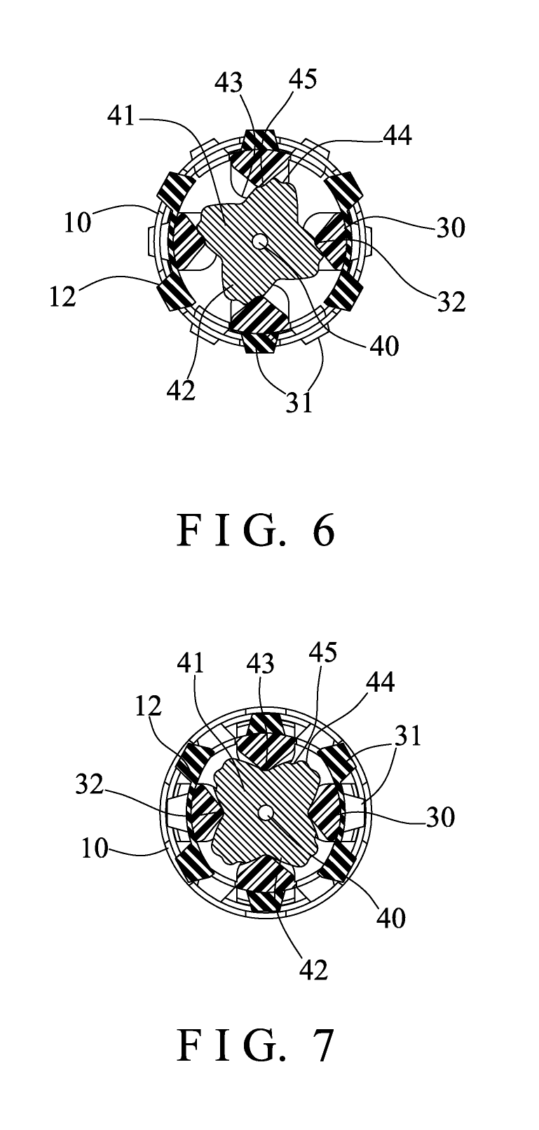

The massaging members 31 of the beams 30 may be forced to move partially out through the orifices 12 of the housing 10 when the bulges 32 of the beams 30 are engaged with the notches 45 of the actuator 41 respectively, as shown in FIG. 6, and the massaging members 31 of the beams 30 may be received or engaged in the housing 10, without moving out through the orifices 12 of the housing 10 when the bulges 32 of the beams 30 are engaged with the recesses 43 of the actuator 41 respectively, as shown in FIG. 7.

One or more (such as two) end caps 50, 51 are rotatably received or engaged with or disposed in the end portions 13, 14 of the housing 10 respectively, and attached or mounted or secured to the end portions 46 of the shaft 40 and moved or rotated in concert with the shaft 40, and the end caps 50, 51 each include a knob 52 formed or provided on the respective end cap 50, 51 for allowing the shaft 40 and the actuator 41 to be pivoted or rotated relative to the housing 10 with either of the end caps 50, 51, and thus for allowing the massaging members 31 of the beams 30 to be moved radially relative to the housing 10 with the actuator 41.

It is preferable that the end caps 50, 51 each further include an actuating element 53 formed or provided on the inner portion thereof, and the actuating elements 53 each include a shape or contour similar or identical to that of the actuator 41, and each include one or more (such as four) projections 54 extended radially and outwardly therefrom for contacting or engaging with the beams 30 respectively, and each include one or more (such as four) recesses 55 formed therein and located between the projections 54 respectively.

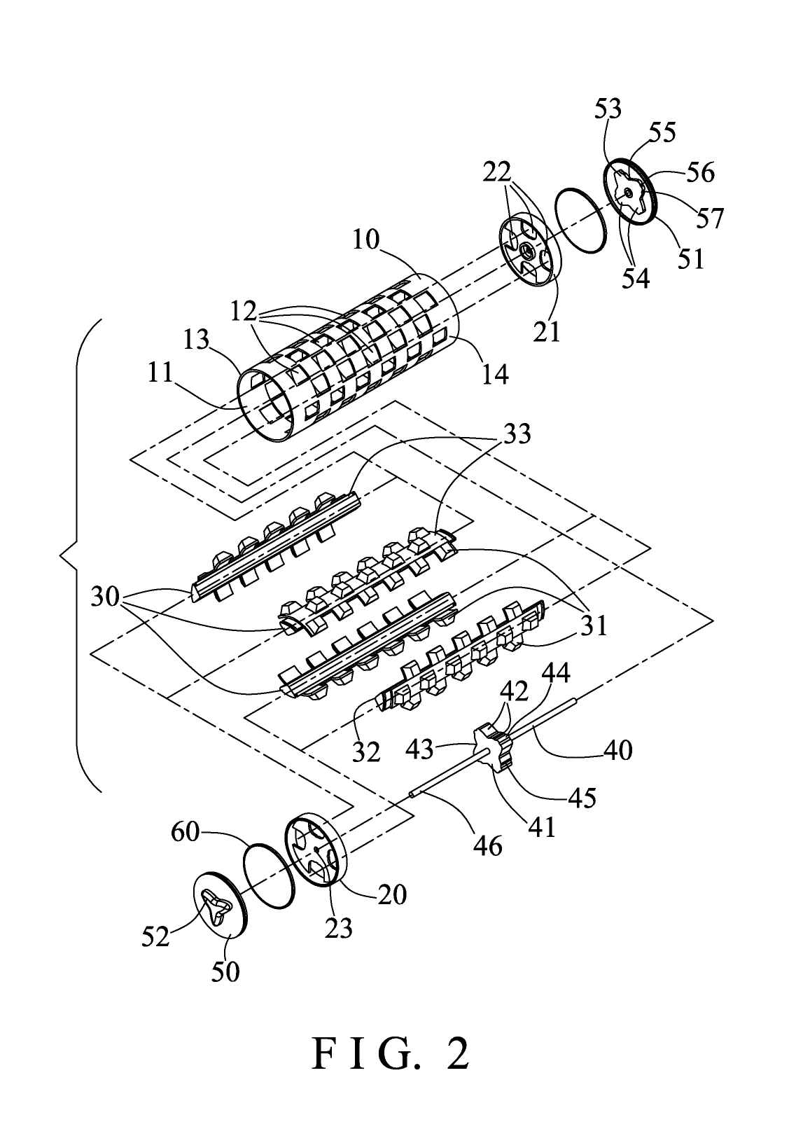

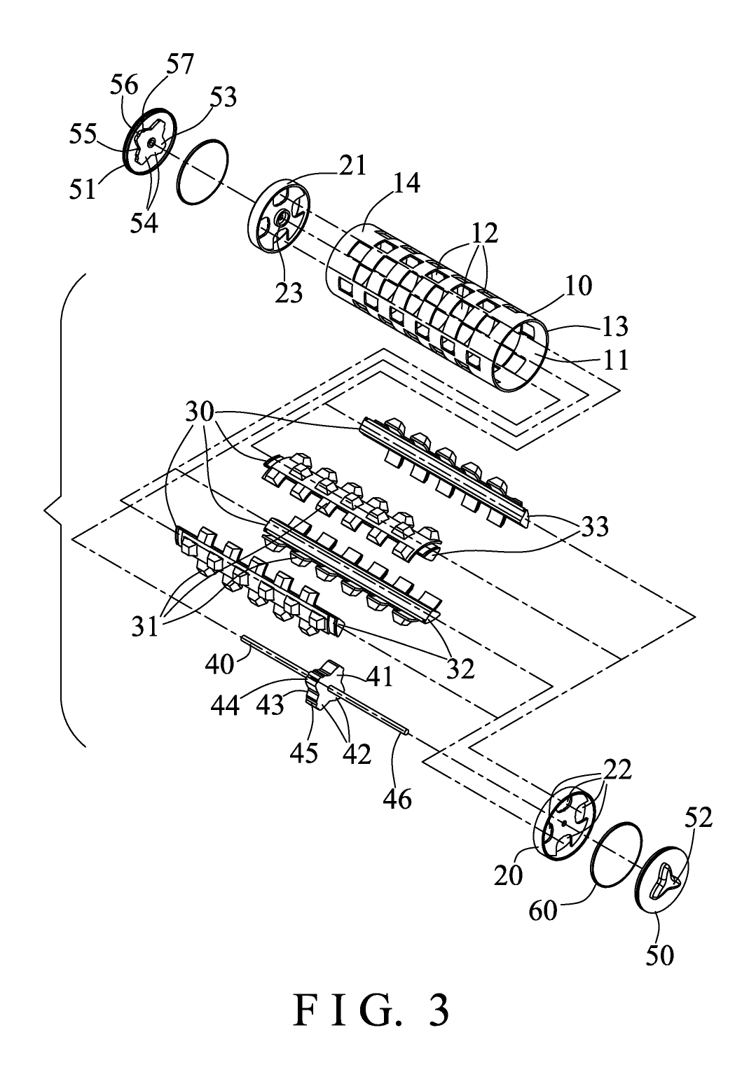

The actuating elements 53 each further include a depression 56 and a notch 57 formed in each of the projections 54 (FIGS. 2-3), in which the depression 56 is located at the tip or outermost end portion of the respective projection 54, and the notch 57 is located between the depression 56 and the recess 55 of the respective projection 54. In operation, the projections 54 of the actuating elements 53 may also be contacted or engaged with the beams 30 for moving and forcing the massaging members 31 of the beams 30 to move relative to the orifices 12 of the housing 10 by engaging the actuating elements 53 with the beams 30 respectively.

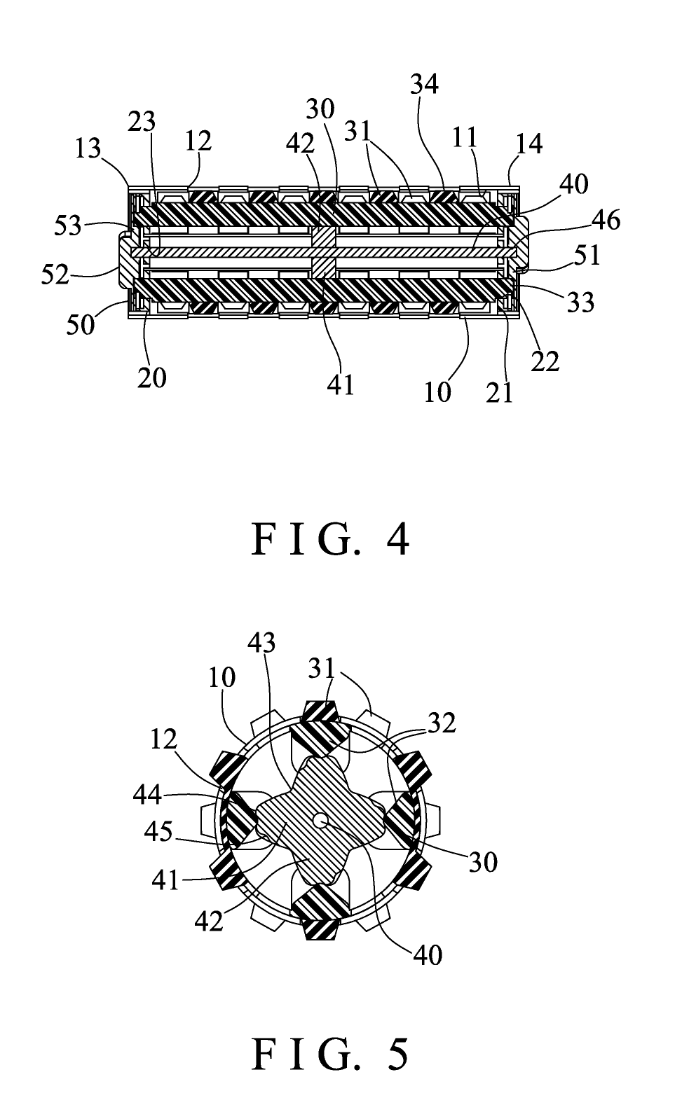

In operation, as shown in FIGS. 4-7, the actuator 41 and/or the actuating elements 53 may be pivoted or rotated relative to the housing 10 with the shaft 40 and either of the end caps 50, 51, and may be contacted or engaged with the beams 30 for forcing and moving the massaging members 31 of the beams 30 radially relative to the housing 10 and for determining or adjusting the protrusion or extending position of the massaging members 31 of the beams 30 relative to the housing 10. For example, as shown in FIG. 7, when the bulges 32 of the beams 30 are engaged with the recesses 43 of the actuator 41 respectively, the massaging members 31 of the beams 30 may be received or engaged in the housing 10, without moving out through the orifices 12 of the housing 10.

As shown in FIG. 6, when the bulges 32 of the beams 30 are engaged with the notches 45 of the actuator 41 respectively, the massaging members 31 of the beams 30 may be forced to move partially out through the orifices 12 of the housing 10 for massaging purposes, and as shown in FIG. 5, when the bulges 32 of the beams 30 are engaged with the depressions 44 of the actuator 41 respectively, the massaging members 31 of the beams 30 may be forced to move out through the orifices 12 of the housing 10 for massaging purposes.

It is to be noted that the actuator 41 may be made or formed to a greater width for stably contacting or engaging with the beams 30 and for stably forcing and moving the massaging members 31 of the beams 30 radially relative to the housing 10 without the actuating elements 53; or, without the actuator 41, the actuating elements 53 may also be stably contacted or engaged with the beams 30 for stably forcing and moving the massaging members 31 of the beams 30 radially relative to the housing 10. Two elastic bands or spring biasing members 60 may further be provided and engaged with the end portions 33 of the beams 30 for biasing and forcing the beams 30 toward and to engage with the actuator 41 and the actuating elements 53.

Accordingly, the massaging device in accordance with the present invention includes an adjustable structure or configuration for adjusting the protrusion or extension of the massaging members and for adjusting the massaging effects to the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
a housing including a chamber formed therein, and including a number of orifices formed in said housing and communicating with said chamber of said housing,
at least one beam received and engaged in said chamber of said housing and movable relative to said housing, and said at least one beam including a plurality of massaging members extended therefrom and aligned with said orifices of said housing respectively, and
an actuator rotatably received and engaged in said chamber of said housing and including at least one protrusion extended therefrom for contacting and engaging with said at least one beam and for moving said massaging members of said at least one beam into and out of said orifices of said housing respectively.

2. The massaging device as claimed in claim 1, wherein said housing includes a shaft rotatably received and engaged in said chamber of said housing and secured to said actuator and moved in concert with said actuator.

3. The massaging device as claimed in claim 2, wherein said housing includes two end portions, and two covers attached to said end portions of said housing respectively, and said shaft includes two end portions rotatably engaged through said covers and rotatably supported in said chamber of said housing with said covers.

4. The massaging device as claimed in claim 3, wherein said covers each include at least one opening formed therein, and said at least one beam includes two end portions slidably engaged with said at least one opening of said cover for guiding said at least one beam to move relative to said housing.

5. The massaging device as claimed in claim 1, wherein said actuator includes at least one recess formed therein for engaging with said at least one beam.

6. The massaging device as claimed in claim 1, wherein said actuator includes a depression formed in said at least one protrusion for engaging with said at least one beam.

7. The massaging device as claimed in claim 1, wherein said actuator includes a notch formed in said at least one protrusion for engaging with said at least one beam.

8. The massaging device as claimed in claim 1, wherein said at least one beam includes a bulge extended therefrom for engaging with said at least one protrusion.

9. The massaging device as claimed in claim 1, wherein said housing includes two end portions, and two end caps disposed in said end portions of said housing respectively, and said end caps each include an actuating element having at least one projection extended therefrom for contacting and engaging with said at least one beam.

10. The massaging device as claimed in claim 9, wherein said actuating elements of said end caps each include at least one recess formed therein for engaging with said at least one beam.

11. The massaging device as claimed in claim 9, wherein said actuating elements of said end caps each include a depression formed in said at least one projection for engaging with said at least one beam.

12. The massaging device as claimed in claim 9, wherein said actuating elements of said end caps each include a notch formed in said at least one projection for engaging with said at least one beam.

13. The massaging device as claimed in claim 9, wherein said end caps each include a knob provided thereon.

14. The massaging device as claimed in claim 9, wherein said at least one beam includes a bulge extended therefrom for engaging with said at least one projection.

15. The massaging device as claimed in claim 1, wherein a spring biasing member is engaged with the said at least one beam for biasing and forcing said at least one beam to engage with the actuator.
